(19) United States
(12) Patent Application Publication
(10) Pub. No.: US 2025/0193868 A1
(43) Pub. Date: Jun. 12, 2025

(54) RADIATED POWER THRESHOLDS FOR BLOCKAGE CONDITIONS AT A USER EQUIPMENT

(71) Applicant: QUALCOMM Incorporated, San Diego, CA (US)

(72) Inventors: Vasanthan RAGHAVAN, West Windsor Township, NJ (US); Mohammad Ali TASSOUDJI, San Diego, CA (US)

(21) Appl. No.: 18/532,507

(22) Filed: Dec. 7, 2023

(51) Int. Cl. H04W 72/044; H04L 5/00; H04W 16/28; H04W 72/51

(52) U.S. Cl. CPC H04W 72/0473; H04L 5/0051; H04W 16/28; H04W 72/51

(57) ABSTRACT

Methods, systems, and devices for wireless communications are described. A user equipment (UE) may receive a control message indicating one or more radiated power thresholds associated with one or more blockage conditions. The one or more blockage conditions may be distinct from a free-space condition. The UE may transmit signaling including information that indicates whether the UE is capable of satisfying the one or more radiated power thresholds when communicating under the one or more blockage conditions. For example, the transmitted signaling may indicate that the UE is capable of satisfying the one or more radiated power thresholds when communicating in accordance with one or more transmission configuration indicator (TCI) states or beamforming procedures. The UE may communicate, based on the information that indicates whether the UE is capable of satisfying the one or more radiated power thresholds, with a network entity via a set of communication resources.

### TECHNICAL FIELD

The following relates to wireless communications, including radiated power thresholds for blockage conditions at a user equipment (UE).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The described techniques relate to improved methods, systems, devices, and apparatuses that support radiated power thresholds for blockage conditions at a user equipment (UE). For example, the described techniques provide for a network entity indicating radiated power thresholds for blockage conditions to the UE, and the UE responding to the network entity with compliance information indicating whether the UE is capable of satisfying the radiated power thresholds. In some examples, in addition to indicating a compliance with the radiated power thresholds, the UE may indicate transmission parameters or configurations that aid the UE in satisfying the radiated power thresholds. For example, the UE may satisfy the radiated power thresholds when the UE communicates using a set of antenna modules, or when the UE is configured with a transmission configuration indicator (TCI) state or a beam management type. The UE may indicate such transmission parameters or configurations to the network entity. The network entity may classify the UE based on a compliance of the UE to the radiated power thresholds and may determine a quality of service (QOS) or resource allocation for the UE according to the classification.

A method for wireless communications by a UE is described. The method may include receiving a control message indicating one or more radiated power thresholds associated with one or more blockage conditions, the one or more blockage conditions distinct from a free-space condition for the UE, transmitting signaling including information that indicates whether the UE is capable of satisfying the one or more radiated power thresholds when communicating under the one or more blockage conditions, and communicating, based on the information that indicates whether the UE is capable of satisfying the one or more radiated power thresholds, with a network entity via a set of communication resources.

A UE for wireless communications is described. The UE may include one or more memories storing processor executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the UE to receive a control message indicating one or more radiated power thresholds associated with one or more blockage conditions, the one or more blockage conditions distinct from a free-space condition for the UE, transmit signaling including information that indicates whether the UE is capable of satisfying the one or more radiated power thresholds when communicating under the one or more blockage conditions, and communicate, based on the information that indicates whether the UE is capable of satisfying the one or more radiated power thresholds, with a network entity via a set of communication resources.

Another UE for wireless communications is described. The UE may include means for receiving a control message indicating one or more radiated power thresholds associated with one or more blockage conditions, the one or more blockage conditions distinct from a free-space condition for the UE, means for transmitting signaling including information that indicates whether the UE is capable of satisfying the one or more radiated power thresholds when communicating under the one or more blockage conditions, and means for communicating, based on the information that indicates whether the UE is capable of satisfying the one or more radiated power thresholds, with a network entity via a set of communication resources.

A non-transitory computer-readable medium storing code for wireless communications at a UE is described. The code may include instructions executable by at least one processor (e.g., directly, indirectly, after pre-processing, without pre-processing) to receive a control message indicating one or more radiated power thresholds associated with one or more blockage conditions, the one or more blockage conditions distinct from a free-space condition for the UE, transmit signaling including information that indicates whether the UE is capable of satisfying the one or more radiated power thresholds when communicating under the one or more blockage conditions, and communicate, based on the information that indicates whether the UE is capable of satisfying the one or more radiated power thresholds, with a network entity via a set of communication resources.

In some examples of the method, UEs, and non-transitory computer-readable medium described herein, transmitting the signaling may include operations, features, means, or instructions for transmitting, via the information, an indication of one or more TCI states from among a set of multiple TCI states supported by the UE, where the information indicates that the UE may be capable of satisfying the one or more radiated power thresholds when communicating in accordance with the one or more TCI states.

In some examples of the method, UEs, and non-transitory computer-readable medium described herein, transmitting the signaling may include operations, features, means, or instructions for transmitting, via the information, an indication of one or more antenna modules from among a set of multiple antenna modules of the UE, where the information indicates that the UE may be capable of satisfying the one or more radiated power thresholds when communicating using the one or more antenna modules.

In some examples of the method, UEs, and non-transitory computer-readable medium described herein, transmitting the signaling may include operations, features, means, or instructions for transmitting, via the information, an indication of one or more beamforming procedures supported by the UE, where the information indicates that the UE may be capable of satisfying the one or more radiated power thresholds when communicating in accordance with the one or more beamforming procedures.

Some examples of the method, UEs, and non-transitory computer-readable medium described herein may further include operations, features, means, or instructions for receiving a message indicating one or more reference signals for measurement at the UE, where the one or more reference signals may be based on the indication of the one or more beamforming procedures supported by the UE.

In some examples of the method, UEs, and non-transitory computer-readable medium described herein, transmitting the signaling may include operations, features, means, or instructions for transmitting, via the information, one or more bits indicating whether the UE may be capable of satisfying the one or more radiated power thresholds when communicating under the one or more blockage conditions.

In some examples of the method, UEs, and non-transitory computer-readable medium described herein, communicating with the network entity may include operations, features, means, or instructions for communicating in accordance with one or more QoS parameters, the one or more QoS parameters based on the information.

Some examples of the method, UEs, and non-transitory computer-readable medium described herein may further include operations, features, means, or instructions for receiving a second control message that indicates the one or more QoS parameters based on the information.

Some examples of the method, UEs, and non-transitory computer-readable medium described herein may further include operations, features, means, or instructions for receiving a message that schedules the set of communication resources, where the set of communication resources may be based on the information.

In some examples of the method, UEs, and non-transitory computer-readable medium described herein, receiving the control message may include operations, features, means, or instructions for receiving, via the control message, a set of multiple radiated power thresholds, each radiated power threshold of the set of multiple radiated power thresholds corresponding to a respective portion of a spherical area surrounding the UE via which one or more signals transmitted by the UE may radiate.

In some examples of the method, UEs, and non-transitory computer-readable medium described herein, the one or more blockage conditions may be associated with an object being within one or more threshold distances of the UE, with one or more respective sizes of the object, or any combination thereof.

In some examples of the method, UEs, and non-transitory computer-readable medium described herein, the object may be a hand of a user or a combination of the hand and a head of the user based on a position of the UE relative to the user of the UE.

A method for wireless communications by a network entity is described. The method may include transmitting a control message indicating one or more radiated power thresholds associated with one or more blockage conditions, the one or more blockage conditions distinct from a free-space condition for a UE, receiving signaling including information that indicates whether the UE is capable of satisfying the one or more radiated power thresholds when communicating under the one or more blockage conditions, and communicating, based on the information that indicates whether the UE is capable of satisfying the one or more radiated power thresholds, with the UE via a set of communication resources.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively operable to execute the code (e.g., directly, indirectly, after pre-processing, without pre-processing) to cause the network entity to transmit a control message indicating one or more radiated power thresholds associated with one or more blockage conditions, the one or more blockage conditions distinct from a free-space condition for a UE, receive signaling including information that indicates whether the UE is capable of satisfying the one or more radiated power thresholds when communicating under the one or more blockage conditions, and communicate, based on the information that indicates whether the UE is capable of satisfying the one or more radiated power thresholds, with the UE via a set of communication resources.

Another network entity for wireless communications is described. The network entity may include means for transmitting a control message indicating one or more radiated power thresholds associated with one or more blockage conditions, the one or more blockage conditions distinct from a free-space condition for a UE, means for receiving signaling including information that indicates whether the UE is capable of satisfying the one or more radiated power thresholds when communicating under the one or more blockage conditions, and means for communicating, based on the information that indicates whether the UE is capable of satisfying the one or more radiated power thresholds, with the UE via a set of communication resources.

A non-transitory computer-readable medium storing code for wireless communications is described. The code may include instructions executable by at least one processor (e.g., directly, indirectly, after pre-processing, without pre-processing) to transmit a control message indicating one or more radiated power thresholds associated with one or more blockage conditions, the one or more blockage conditions distinct from a free-space condition for a UE, receive signaling including information that indicates whether the UE is capable of satisfying the one or more radiated power thresholds when communicating under the one or more blockage conditions, and communicate, based on the information that indicates whether the UE is capable of satisfying the one or more radiated power thresholds, with the UE via a set of communication resources.

In some examples of the method, network entities, and non-transitory computer-readable medium described herein, receiving the signaling may include operations, features, means, or instructions for receiving, via the information, an indication of one or more TCI states from among a set of multiple TCI states supported by the UE, where the information indicates that the UE may be capable of satisfying the one or more radiated power thresholds when communicating in accordance with the one or more TCI states.

In some examples of the method, network entities, and non-transitory computer-readable medium described herein, receiving the signaling may include operations, features, means, or instructions for receiving, via the information, an indication of one or more antenna modules from among a set of multiple antenna modules of the UE, where the information indicates that the UE may be capable of satisfying the one or more radiated power thresholds when communicating using the one or more antenna modules.

In some examples of the method, network entities, and non-transitory computer-readable medium described herein, receiving the signaling may include operations, features, means, or instructions for receiving, via the information, an indication of one or more beamforming procedures supported by the UE, where the information indicates that the UE may be capable of satisfying the one or more radiated power thresholds when communicating in accordance with the one or more beamforming procedures.

Some examples of the method, network entities, and non-transitory computer-readable medium described herein may further include operations, features, means, or instructions for transmitting a message indicating one or more reference signals for measurement at the UE, where the one or more reference signals may be based on the indication of the one or more beamforming procedures supported by the UE.

In some examples of the method, network entities, and non-transitory computer-readable medium described herein, receiving the signaling may include operations, features, means, or instructions for receiving, via the information, one or more bits indicating whether the UE may be capable of satisfying the one or more radiated power thresholds when communicating under the one or more blockage conditions.

In some examples of the method, network entities, and non-transitory computer-readable medium described herein, communicating with the UE may include operations, features, means, or instructions for communicating in accordance with one or more QoS parameters, the one or more QoS parameters based on the information.

Some examples of the method, network entities, and non-transitory computer-readable medium described herein may further include operations, features, means, or instructions for transmitting a second control message that indicates the one or more QoS parameters based on the information.

Some examples of the method, network entities, and non-transitory computer-readable medium described herein may further include operations, features, means, or instructions for transmitting a message that schedules the set of communication resources, where the set of communication resources may be based on the information.

In some examples of the method, network entities, and non-transitory computer-readable medium described herein, transmitting the control message may include operations, features, means, or instructions for transmitting, via the control message, a set of multiple radiated power thresholds, each radiated power threshold of the set of multiple radiated power thresholds corresponding to a respective portion of a spherical area surrounding the UE via which one or more signals transmitted by the UE may radiate.

In some examples of the method, network entities, and non-transitory computer-readable medium described herein, the one or more blockage conditions may be associated with an object being within one or more threshold distances of the UE, with one or more respective sizes of the object, or any combination thereof.

In some examples of the method, network entities, and non-transitory computer-readable medium described herein, the object may be a hand of a user or a combination of the hand and a head of the user based on a position of the UE relative to the user of the UE.

### BRIEF DESCRIPTION OF THE DRAWINGS

FIG. 1 shows an example of a wireless communications system that supports radiated power thresholds for blockage conditions at a user equipment (UE) in accordance with one or more aspects of the present disclosure.

FIG. 2 shows an example of a wireless communications system that supports radiated power thresholds for blockage conditions at a UE in accordance with one or more aspects of the present disclosure.

FIG. 3 shows an example of a radiated power graph that supports radiated power thresholds for blockage conditions at a UE in accordance with one or more aspects of the present disclosure.

FIG. 4 shows an example of a process flow that supports radiated power thresholds for blockage conditions at a UE in accordance with one or more aspects of the present disclosure.

FIGS. 5 and 6 show block diagrams of devices that support radiated power thresholds for blockage conditions at a UE in accordance with one or more aspects of the present disclosure.

FIG. 7 shows a block diagram of a communications manager that supports radiated power thresholds for blockage conditions at a UE in accordance with one or more aspects of the present disclosure.

FIG. 8 shows a diagram of a system including a device that supports radiated power thresholds for blockage conditions at a UE in accordance with one or more aspects of the present disclosure.

FIGS. 9 and 10 show block diagrams of devices that support radiated power thresholds for blockage conditions at a UE in accordance with one or more aspects of the present disclosure.

FIG. 11 shows a block diagram of a communications manager that supports radiated power thresholds for blockage conditions at a UE in accordance with one or more aspects of the present disclosure.

FIG. 12 shows a diagram of a system including a device that supports radiated power thresholds for blockage conditions at a UE in accordance with one or more aspects of the present disclosure.

FIGS. 13 through 17 show flowcharts illustrating methods that support radiated power thresholds for blockage conditions at a UE in accordance with one or more aspects of the present disclosure.

### DETAILED DESCRIPTION

In some wireless communications systems, a network entity may configure specifications (e.g., requirements) for a user equipment (UE). The network entity may admit the UE to a network based on the UE satisfying the specifications. The specifications may specify thresholds for a radiated power (e.g., effective isotropic radiated power (EIRP), effective isotropic sensitivity (EIS), among other examples) which may indicate a performance of signals transmitted or received by the UE. For example, the UE may estimate (e.g., calculate) a cumulative distribution function (CDF) of radiated power based on a set of signals that radiate around a spherical area surrounding the UE. The specifications may indicate different radiated power thresholds for a peak performance of the UE (e.g., 100th percentile of the CDF), a median performance of the UE (e.g., 50th percentile of the CDF), or other performance metrics (e.g., 20th percentile of the CDF, among other examples). The specifications may be applicable to the UE while the UE communicates in a free-space environment with no (e.g., or relatively minimal) blockage, such as in a testing facility before deployment of the UE in the field, in a chamber, or in any space with lack of a human hand or other barrier that may at least partially block (e.g., obstruct, interfere with, be within a line-of-sight for communications via, degrade signal quality for) one or more antennas of the UE. However, a performance of the UE in a real-world environment may be impacted by blockage conditions, where objects may be proximal to the UE and may block or otherwise interfere with signals transmitted by the UE. Thus, existing specifications, which fail to account for the impacts of blockage, may be insufficient in accurately assessing UE performance within a network.

In accordance with examples described herein, the UE and the network entity may support dynamic indication of radiated power thresholds in blockage scenarios. The radiated power thresholds may be network operator dependent and may serve as an indicator of UE performance in the real-world environment. The network entity may indicate the radiated power thresholds to a UE, and the UE may respond with compliance information. In some examples, the compliance information may include one or more bits (e.g., indicating yes/no to a series of requirements) that indicates whether the UE satisfies the radiated power thresholds. In other examples, the UE may indicate one or more parameters related to the UE satisfying the radiated power thresholds. For example, the UE may indicate that the UE satisfies the radiated power thresholds while communicating in accordance with a set of transmission configuration indicator (TCI) states or in accordance with one or more beamforming procedures (e.g., codebook based, adaptive beam weights). The network entity may classify UEs based on the reported compliance information from the UE, and the network entity may serve UEs that comply with the radiated power thresholds with a greater quality of service (QoS) or with UE-specific resource allocations.

Aspects of the disclosure are initially described in the context of wireless communications systems. Aspects of the disclosure are further described in the context of a radiated power graph and a process flow. Aspects of the disclosure are further illustrated by and described with reference to apparatus diagrams, system diagrams, and flowcharts that relate to radiated power thresholds for blockage conditions at a UE.

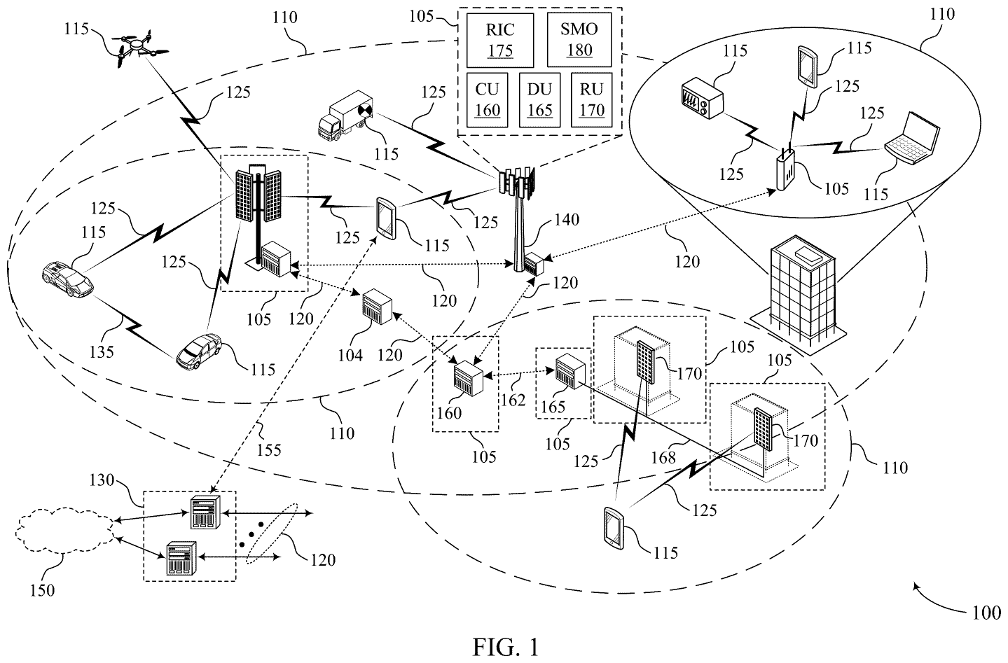

FIG. 1 shows an example of a wireless communications system 100 that supports radiated power thresholds for blockage conditions at a UE in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support radiated power thresholds for blockage conditions at a UE as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a UE 115 may receive, from a network entity 105, a control message indicating one or more radiated power thresholds associated with one or more blockage conditions. The one or more blockage conditions may be distinct from a free-space condition (e.g., a test environment in which there are no objects or other blockages in proximity of the UE 115). The UE 115 may transmit signaling including information that indicates whether the UE 115 is capable of satisfying the one or more radiated power thresholds when communicating under the one or more blockage conditions. For example, the transmitted signaling may indicate that the UE 115 is capable of satisfying the one or more radiated power thresholds when communicating in accordance with one or more TCI states or beamforming procedures. The UE 115 may communicate, based on the information that indicates whether the UE 115 is capable of satisfying the one or more radiated power thresholds, with a network entity 105 via a set of communication resources.

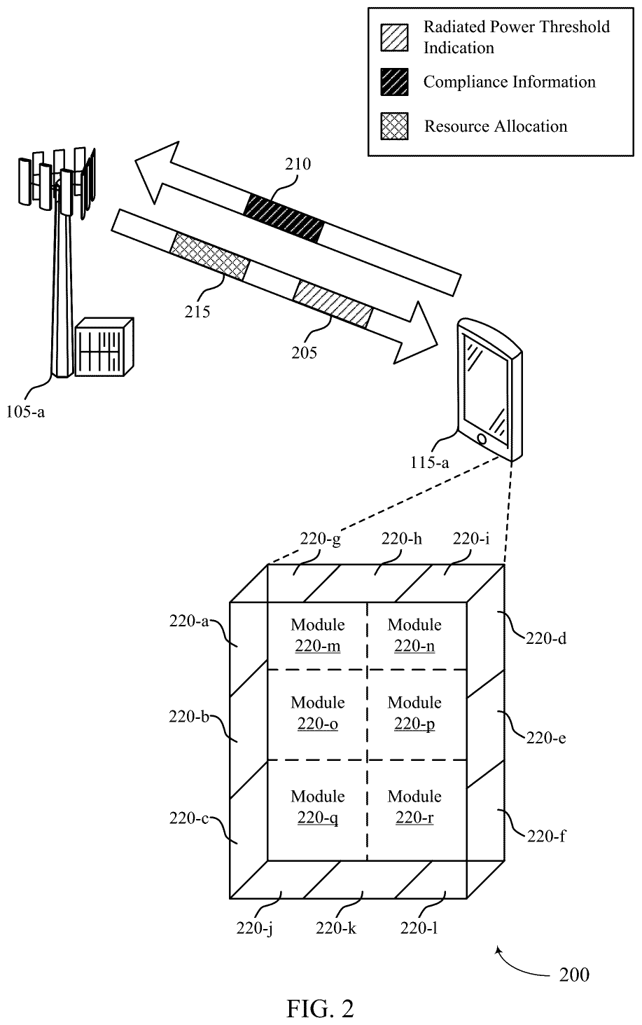

FIG. 2 shows an example of a wireless communications system 200 that supports radiated power thresholds for blockage conditions at a UE in accordance with one or more aspects of the present disclosure. The wireless communications system 200 may implement, or may be implemented by, aspects of the wireless communications system 100. For example, the wireless communications system 200 may include a UE 115-a and a network entity 105-a, which may be examples of corresponding devices as described herein.

The UE 115-a and the network entity 105-a may use multiple antennas (e.g., multiple antenna modules 220) in some wireless communications systems (e.g., in millimeter wave systems). Beamforming from multiple antennas may bridge a link budget in such systems. To realize beamforming gains, a wireless communication device, such as the network entity 105-a, may construct an analog or hybrid beamforming codebook and may store the codebook in a radio frequency integrated circuit (RFIC) memory. Each entry in the beamforming codebook may include a set of beam weights which may be phase shifter and amplitude control combinations. In some examples, the beamforming codebook may include beam weights that steer energy around fixed directions within a vicinity of the boresight direction of an antenna array.

In some wireless communications systems, the network entity 105-a may specify performance specifications (e.g., requirements) of the UE 115-a. The network entity 105-a may utilize the performance specifications to filter multiple UEs 115 as to which of the multiple UEs 115 the network entity 105-a may grant admittance into the network. For example, the network entity 105-a may serve the UE 115-a if the UE 115-a meets the performance specifications or may not serve the UE 115-a (e.g., may deny the UE 115-a admittance into the network) if the UE 115-a fails to meet the performance specifications. The network entity 105-a may admit the UE 115-a to the network based on a conformance testing procedure, by which the network entity 105-a may determine that the UE 115-a satisfies the performance specifications.

The network entity 105-a may specify the performance specifications in the form of spherical coverage metrics associated with radiated power, such as an EIRP or an EIS. Radiated power specifications for uplink may be based on an EIRP, and radiated power specifications for downlink may be based on an EIS. The network entity 105-a may indicate different radiated power specifications (e.g., radiated power thresholds) across different bands or for different UE power classes, for example, by indicating a respective radiated power specification for each band of a set of bands, for each UE power class of a set of UE power classes, or a combination thereof.

The UE 115-a may estimate (e.g., calculate) a CDF of radiated power based on a set of signals that radiate around a spherical area surrounding the UE 115-a. The performance specifications may indicate different radiated power thresholds for different percentile points of the CDF. For example, the specifications may indicate a first radiated power threshold for a 100th percentile of the CDF (e.g., a peak performance), a second radiated power threshold for a 50th percentile of the CDF (e.g., a median performance), a third radiated power for a 20th percentile of the CDF, among other percentile points of the CDF. In some other examples, each of the first, second, and third radiated power thresholds may correspond to a respective portion (e.g., 100 percent, 50 percent, 20 percent) of a spherical area surrounding the UE 115-a via which one or more signals transmitted by the UE 115-a may radiate.

The radiated power specifications may apply for free-space or no blockage conditions. For example, the radiated power specifications may apply to conditions with no (e.g., or relatively minimal) blockage. Examples of a free-space or no blockage condition may include a testing facility pre-deployment of the UE 115-a, a chamber, or any space which lacks a presence of a human hand or other physical barrier that may at least partially block one or more antenna modules 220 of the UE 115-a. The network entity 105-a may thereby admit the UE 115-a to the network based on satisfaction of the radiated power specifications during a testing procedure in free-space conditions (e.g., before deployment of the UE 115-a).

However, after the UE 115-a is admitted into the network based on satisfaction of the radiated power specifications, a performance of the UE 115-a may suffer due to various impairments associated with the UE 115-a being located in or operating in a field different from the free-space operating conditions (e.g., in real-world applications, in blockage scenarios). For example, a performance of the UE 115-a may decrease or deteriorate, relative to the free-space condition, due to blockage from one or more objects in the field.

The network entity 105-a may modify radiated power specifications in various ways to improve an efficacy of the specifications in assessing UE performance for blockage conditions. For example, the network entity 105-a may utilize radiated power specifications at lower percentile points of the CDF (compared to existing specifications) for a free-space condition. The network entity 105-a may introduce additional power classes, each of the additional power classes having a corresponding peak radiated power threshold or corresponding radiated power thresholds at different percentile points of the CDF. The network entity 105-a may indicate a threshold quantity of antenna modules at the UE 115-a for admittance into the network. However, such modifications to the radiated power specifications may be associated with a relatively high complexity or cost of implementation.

In accordance with examples described herein, the network entity 105-a may indicate, in addition to radiated power specifications for a free-space or no blockage condition, radiated power specifications (e.g., thresholds) for blockage conditions via a radiated power threshold indication 205, which may support an increased on-field performance of the UE 115-a. In some examples, the UE 115-a may indicate, via compliance information 210, a dynamic satisfaction of the radiated power specifications for blockage conditions. The compliance information 210 may be uplink signaling that includes a binary indication (e.g., yes/no to a series of requirements) or includes information that may indicate satisfaction of the radiated power specifications based on a TCI state or a type of beamforming, or both. In some examples, the radiated power specifications for blockage conditions may enable the network entity 105-a to determine a quality of a link between the UE 115-a and the network entity 105-a, and the network entity 105-a may provide differential services or resources (e.g., via a resource allocation message 215), or both, to the UE 115-a based on the UE 115-a satisfying the radiated power specifications for blockage conditions.

In some examples, the radiated power specifications for blockage conditions may be network operator dependent (e.g., may be different from one network entity 105 to another), and the network entity 105-a may signal the radiated power specifications for blockage conditions over-the-air via the radiated power threshold indication 205. For example, the network entity 105-a may transmit the radiated power threshold indication 205 via a RRC signaling, MAC-control element (MAC-CE) signaling, downlink control information (DCI) signaling, or a combination thereof. In some examples, the radiated power specifications for blockage conditions may not impact an admittance of the UE 115-a to the network. Rather, the radiated power specifications for blockage conditions may serve as a benchmark or threshold for performance of the UE 115-a while operating in the field.

The radiated power specifications for blockage conditions (e.g., to complement radiated power specifications for free-space conditions) may indicate minimum thresholds of EIRP, EIS, or both, at one or more percentile points of the CDF and for one or more blockage scenarios. For example, Table 1 illustrates an example of minimum EIRP thresholds for a free-space condition, a first blockage condition, and a second blockage condition at a 100th percentile point of the CDF (e.g., peak performance), a 50th percentile point of the CDF (e.g., median performance), and a 20th percentile point of the CDF (e.g., tail performance).

TABLE 1

| | Minimum EIRP in decibel-milliwatts (dBm) | | |
|---|---|---|---|
| | | Hand blockage | Besides head and |
| | | on left/ | hand blockage on |
| | Free-space | right side | left/right side |
| CDF Percentile | Condition | (HL/HR) | (BHHL/BHHR) |
| 100th Percentile | 26.9 | 25.9 | 22.9 |
| 50th Percentile | 19.9 | 14.9 | 11.9 |
| 20th Percentile | 15.0 | 8.0 | 5.0 |

In this example, the first blockage condition may correspond to a hand on a left side (HL) of the UE 115-a or a hand on a right side (HR) of the UE 115-a. The second blockage condition may correspond to besides head and hand on the left side (BHHL) of the UE 115-a or a besides head and hand on the right side (BHHR) of the UE 115-a. Examples of the one or more blockage conditions may additionally include an object (e.g., head, hand, or some other object) being within one or more threshold distances of the UE 115-a, an object being a threshold size, or any combination thereof. The radiated power specifications for blockage conditions may apply to one or more bands, one or more UE power classes, or a combination thereof. The radiated power specifications for blockage conditions may be less than corresponding radiated power specifications for a free-space condition, in some cases, such as in the example radiated power specifications illustrated in Table 1.

The UE 115-a may indicate, via the compliance information 210, that the UE 115-a satisfies the radiated power specifications for blockage conditions. In some examples, the UE 115-a may transmit a first message that includes a binary indication (e.g., one or more bits) indicating that the UE 115-a satisfies the radiated power specifications for blockage conditions. In some such examples, the network entity 105-a may query the UE 115-a for additional information or capabilities relating to a performance of the UE 115-a when communicating in the one or more blockage conditions. The UE 115-a may transmit (e.g., in response to the query) a second message that indicates that the UE 115-a satisfies the radiated power specifications for blockage conditions when communicating using one or more transmission parameters.

The UE 115-a may have two or more antenna modules 220 at two or more different locations of the UE 115-a. In the example of FIG. 2, a surface of the UE 115-a may be divided into 18 partitions. A left edge of the UE 115-a may include an antenna module 220-a, an antenna module 220-b, and an antenna module 220-c. A right edge of the UE 115-a may include an antenna module 220-d, an antenna module 220-e, and an antenna module 220-f. A top edge of the UE 115-a may include an antenna module 220-g, an antenna module 220-h, and an antenna module 220-i. A bottom edge of the UE 115-a may include an antenna module 220-j, an antenna module 220-k, and an antenna module 220-1. A back face of the UE 115-a may include an antenna module 220-m, an antenna module 220-n, an antenna module 220-o, an antenna module 220-p, an antenna module 220-q, and an antenna module 220-r. Each of the antenna modules 220 may represent a candidate placement for one antenna module 220 from a quantity of active antenna modules 220 that the UE 115-a supports. Accordingly, in an example where the UE 115-a supports two active antenna modules 220, there may exist (18), or 153, candidate antenna module placement combinations for the two active antenna modules 220. Although 18 antenna modules are illustrated in FIG. 2, it is to be understood that a UE 115 may include any quantity of antenna modules positioned in any combination of locations on the UE 115.

A spherical coverage of the UE 115-a, expressed in EIRP or EIS, may be based on a location of one or more antenna modules 220 at the UE 115-a. Each of the antenna module placement combinations may correspond to a radiated power (e.g., an array gain). For example, an array gain for two antenna modules 220 placed on either of the left or right edge may be 0 dB at a 50th percentile point of the CDF, whereas two antenna modules placed on the bottom edge may correspond to an array gain of −2.5 dB at the 50th percentile point. Depending on antenna module locations, the UE 115-a may meet the radiated power specifications for blockage conditions at a percentile point of the CDF, or the UE 115-a may fail to meet the radiated power specifications.

In cases where the UE 115-a is equipped with multiple antenna modules at different locations, some sets (e.g., pairs) of antenna modules may meet the radiated power specifications, and other sets (e.g., pairs) of antenna modules may fail to meet the radiated power specifications. As such, the UE 115-a may dynamically select or activate a subset of one or more antenna modules 220 from an available set of one or more antenna modules 220 at the UE 115-a, and the selected or activated subset of antenna modules 220 may enable the UE 115-a to satisfy the radiated power specifications for blockage conditions.

In some examples, whether the subset of antenna modules 220 satisfies the radiated power thresholds may be based on a type of beam management (e.g., beamforming procedure) that the UE 115-a uses or that is available at the UE 115-a. For example, the antenna module 220-a, the antenna module 220-d, and the antenna module 220-g may be available for use by the UE 115-a. A combination of the antenna module 220-a and the antenna module 220-d may fail to meet the radiated power thresholds regardless of beam management type. However, a combination of the antenna module 220-a and the antenna module 220-g, or a combination of the antenna module 220-d and the antenna module 220-g, may meet the radiated power thresholds when beam management is performed using adaptive beam weights (e.g., instead of a codebook-based beamforming type). In some examples, any combination of the antenna module 220-a, the antenna module 220-d, and the antenna module 220-g may fail to meet the radiated power thresholds at a 10th percentile point or a 20th percentile point of the CDF. However, a combination of the antenna module 220-a and the antenna module 220-g, or a combination of the antenna module 220-d and the antenna module 220-g, may meet the radiated power thresholds at a 50th percentile point of the CDF.

In some examples, the UE 115-a may indicate, via the compliance information 210, one or more sets of antenna modules that enable the UE 115-a to meet the radiated power specifications for blockage conditions. For example, the compliance information 210 may indicate that the UE 115-a is capable of satisfying one or more radiated power thresholds when communicating using the one or more sets of antenna modules. The UE 115-a may also indicate, for each set of antenna modules that enables the UE 115-a to meet the radiated power specifications, a respective beam management type (e.g., adaptive beam weights, codebook-based beam management) by which the set of antenna module enables the UE 115-a to meet the radiated power specifications. TCI states may correspond to different sets of antenna modules at the UE 115-a. In other words, a TCI state may serve as an indicator of a set of antenna modules. The UE 115-a may indicate, via the compliance information 210, a subset of TCI states, from a set of TCI states configured for the UE 115-a, that enable the UE 115-a to meet the radiated power specifications for blockage conditions. That is, the compliance information 210 may indicate that the UE is capable of satisfying the one or more radiated power thresholds when communicating in accordance with the subset of TCI states.

In some examples, based on receiving the compliance information 210, the network entity 105-a may classify UEs 115. For example, the network entity 105-a may group multiple UEs 115 into one or more groups or classifications. The network entity 105-a may serve groups or classifications of UEs 115 that indicate relatively higher performance metrics (e.g., relatively greater compliance with one or more radiated power thresholds) with a relatively greater QoS (e.g., higher QoS rates or higher modulation and coding schemes (MCSs)). In some examples, the network entity 105-a may indicate one or more QoS parameters to the UE 115-a via a resource allocation message 215.

In some examples, based on receiving the compliance information 210, the network entity 105-a may indicate to the UE 115-a, via the resource allocation message 215, a UE-specific resource allocation for a set of communication resources. Additionally, or alternatively, the resource allocation message 215 may indicate one or more reference signals for measurement at the UE 115-a. The reference signals may be associated with a relatively higher performance relative to reference signals configured for measurement at other UEs 115. In some examples, the resource allocation message 215 may indicate a TCI state for activation at the UE 115-a based on the compliance information 210. The network entity 105-a may thereby adjust communication parameters, such as QoS, resource allocation, other communication parameters, or any combination thereof, based on the UE classification, which may provide for improved throughput and communication reliability with various UEs 115 in the network.

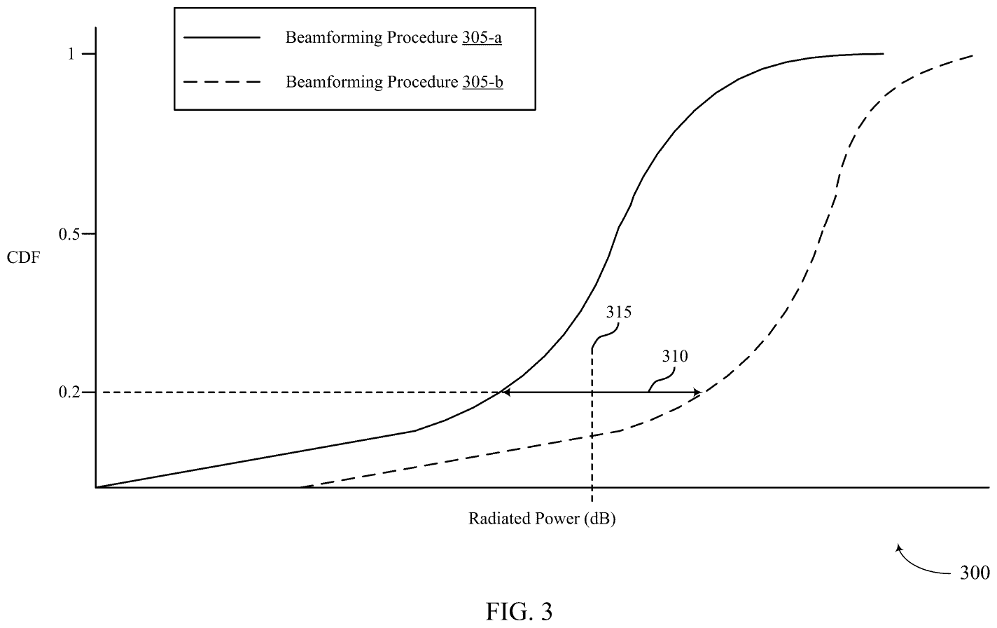

FIG. 3 shows an example of a radiated power graph 300 that supports radiated power thresholds for blockage conditions at a UE in accordance with one or more aspects of the present disclosure. The radiated power graph 300 may implement, or may be implemented by, aspects of the wireless communications system 100 or the wireless communications system 200. For example, the radiated power graph may depict a radiated power, across varying percentile points of a CDF, of one or more signals transmitted by a UE 115, as described with reference to FIGS. 1 and 2.

In some examples, a radiated power (e.g., EIRP, EIS) of a UE may be based on a type of beam management (e.g., beam management overhead) that the UE uses or is configured with. In one example, the UE may use a beamforming procedure 305-a, which may be based on a static codebook size (e.g., size-9 codebook of steered beams, or some other size to cover a 5×1 dual-polarized array, or some other size of array). In another example, the UE may use a beamforming procedure 305-b, which may be based on a set of adaptive beam weights for beamforming (e.g., thereby improving tail performance). The UE may not be limited by the beamforming procedure 305-a and the beamforming procedure 305-b and may use any other beamforming procedure 305. Each beamforming procedure 305 may correspond to a respective overhead of a beam training procedure (e.g., beam weight learning), a respective latency associated with the beam training procedure, a respective power consumption associated with the beam training procedure, or a combination thereof.

Beam training overhead, latency, and power consumption for the beamforming procedure 305-a may be fixed and may be based on the codebook size that is scanned or searched, in some examples. Additionally, or alternatively, beam training overhead, latency, and power consumption for the beamforming procedure 305-b may be proportional to array dimensions, link quality, or accuracy of beam weights, which may lead to a commensurate increase in power relative to the beamforming procedure 305-a. For a set of antenna modules at a UE (e.g., top+left, top+right, or left+right), depending on which of the beamforming procedures 305 is used or available at the UE, or an antenna module structure, or both, the UE may satisfy radiated power specifications for blockage conditions at one or more percentile points of a CDF, or the UE may fail to satisfy radiated power specifications for blockage conditions at one or more percentile points of the CDF. For example, for a 20th percentile point of the CDF, a radiated power for the beamforming procedure 305-a may differ from that for the beamforming procedure 305-b by a difference 310. The network entity may indicate a radiated power threshold 315 for the 20th percentile point. The UE may satisfy the radiated power threshold 315 for the 20th percentile using the beamforming procedure 305-b, but the UE may fail to satisfy the radiated power threshold 315 for the 20th percentile using the beamforming procedure 305-a.

In some examples, the UE may indicate (e.g., via compliance information 210, as described with reference to FIG. 2) a type of beamforming (e.g., a beamforming procedure) which the UE may use to meet the radiated power specifications for blockage conditions. The indication may inform a network entity as to what type of reference signal configuration to indicate to the UE. For example, the network entity 105-a may indicate for the UE to measure and report on (e.g., via a CSI report configuration) a UE-specific aperiodic CSI for an adaptive beam weight beamforming procedure, or may indicate for the UE to measure and report on a synchronization signal block (SSB) for fixed-size static beam codebook beamforming procedure. That is, the UE may receive a message indicating one or more reference signals for measurement, and the one or more reference signals may be based on the indication of one or more beamforming procedures supported by the UE.

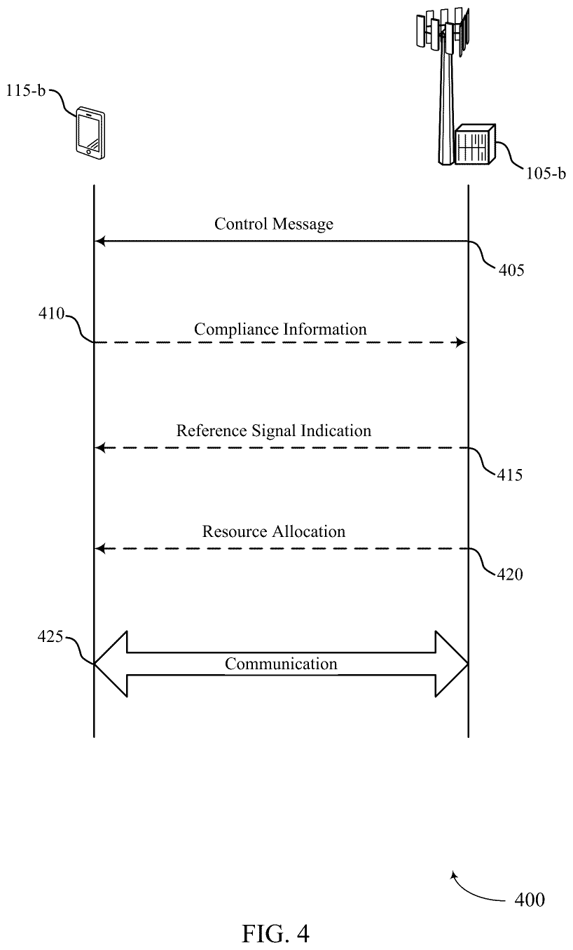

FIG. 4 shows an example of a process flow 400 that supports radiated power thresholds for blockage conditions at a UE in accordance with one or more aspects of the present disclosure. The process flow 400 may implement, or may be implemented by, aspects of the wireless communications system 100 or the wireless communications system 200. For example, the process flow 400 may include a UE 115-b and a network entity 105-b, which may be examples of corresponding devices as described herein.

In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive a control message indicating one or more radiated power thresholds (e.g., radiated power specifications or requirements) associated with one or more blockage conditions (e.g., HL/HR, BHHL/BHHR). The one or more blockage conditions may be distinct from a free-space condition (e.g., a no blockage condition) for the UE. The control message may be an RRC message, a MAC-CE, a DCI message, or a combination thereof.

At 410, the UE 115-b may transmit signaling including information (e.g., compliance information) that indicates whether the UE 115-b is capable of satisfying the one or more radiated power thresholds when communicating under the one or more blockage conditions. In some examples, the UE 115-b may transmit, via the information, an indication of one or more TCI states from among a set of multiple TCI states supported by the UE. The UE 115-b may transmit, via the message, an indication of one or more antenna modules (e.g., one or more sets of antenna modules) from among a set of multiple antenna modules of the UE 115-b. Additionally, or alternatively, the UE 115-b may transmit, via the message, an indication of one or more beamforming procedures (e.g., beam management types) supported by the UE.

The information may indicate that the UE is capable of satisfying the one or more radiated power thresholds when communicating using the one or more antenna modules, in accordance with the one or more TCI states, in accordance with the one or more beamforming procedures, or a combination thereof. In some examples, the UE 115-b may transmit one or more bits (e.g., a single bit indicating acknowledgment (ACK) or non-acknowledgment (NACK)) indicating whether the UE 115-b is capable of satisfying the one or more radiated power thresholds when communicating under the one or more blockage conditions. The UE 115-b may transmit the signaling via an uplink control information (UCI) message.

At 415, the UE 115-b may receive a message (e.g., a CSI report configuration) indicating one or more reference signals (e.g., CSI-RSs, SSBs) for measurement at the UE 115-b. The one or more reference signals may be based on the indication (e.g., at 410) of the one or more beamforming procedures supported by the UE 115-b.

At 420, the UE 115-b may receive a message (e.g., DCI) that schedules a set of communication resources. The set of communication resources may be based on the information that indicates whether the UE 115-b is capable of satisfying the one or more radiated power thresholds.

At 425, the UE 115-b may communicate with the network entity 105-b via the set of communication resources. The communication may be based on the information that indicates whether the UE 115-b is capable of satisfying the one or more radiated power thresholds. For example, the UE 115-b may communicate in accordance with one or more QoS parameters. The QoS parameters may be based on the information that indicates whether the UE 115-b is capable of satisfying the one or more radiated power thresholds.

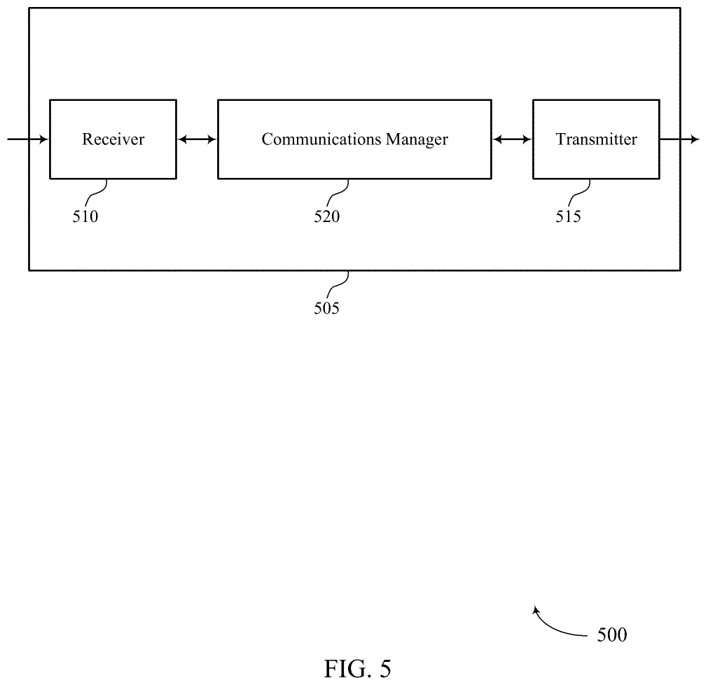

FIG. 5 shows a block diagram 500 of a device 505 that supports radiated power thresholds for blockage conditions at a UE in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to radiated power thresholds for blockage conditions at a UE). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to radiated power thresholds for blockage conditions at a UE). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of radiated power thresholds for blockage conditions at a UE as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a graphics processing unit (GPU), a neural processing unit (NPU), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor. If implemented in code executed by at least one processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a control message indicating one or more radiated power thresholds associated with one or more blockage conditions, the one or more blockage conditions distinct from a free-space condition for the UE. The communications manager 520 is capable of, configured to, or operable to support a means for transmitting signaling including information that indicates whether the UE is capable of satisfying the one or more radiated power thresholds when communicating under the one or more blockage conditions. The communications manager 520 is capable of, configured to, or operable to support a means for communicating, based at least in part on the information that indicates whether the UE is capable of satisfying the one or more radiated power thresholds, with a network entity via a set of communication resources.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources. For example, a network entity may prioritize UEs based on capabilities of the UEs to satisfy various radiated power thresholds, which may result in a more efficient allocation of resources to the UEs. The network entity may expend less processing power to serve UEs with a relatively weaker performance, which may support reduced processing and power consumption.

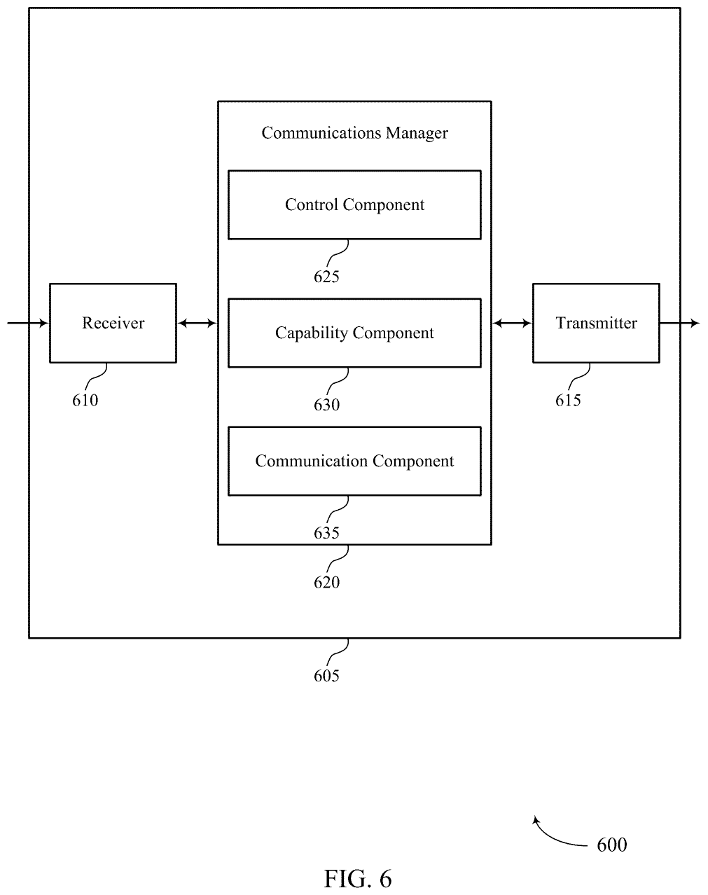

FIG. 6 shows a block diagram 600 of a device 605 that supports radiated power thresholds for blockage conditions at a UE in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to radiated power thresholds for blockage conditions at a UE). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to radiated power thresholds for blockage conditions at a UE). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of radiated power thresholds for blockage conditions at a UE as described herein. For example, the communications manager 620 may include a control component 625, a capability component 630, a communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control component 625 is capable of, configured to, or operable to support a means for receiving a control message indicating one or more radiated power thresholds associated with one or more blockage conditions, the one or more blockage conditions distinct from a free-space condition for the UE. The capability component 630 is capable of, configured to, or operable to support a means for transmitting signaling including information that indicates whether the UE is capable of satisfying the one or more radiated power thresholds when communicating under the one or more blockage conditions. The communication component 635 is capable of, configured to, or operable to support a means for communicating, based on the information that indicates whether the UE is capable of satisfying the one or more radiated power thresholds, with a network entity via a set of communication resources.

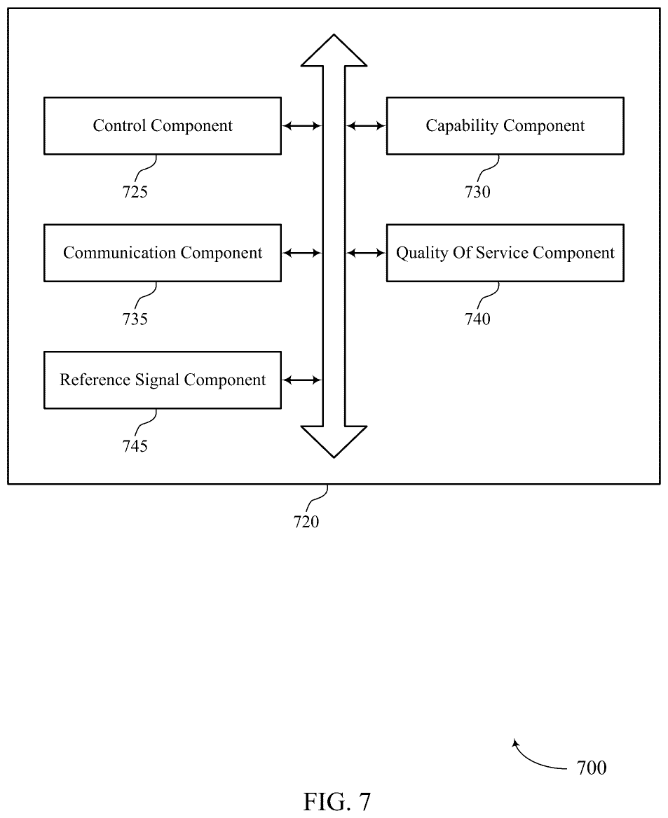

FIG. 7 shows a block diagram 700 of a communications manager 720 that supports radiated power thresholds for blockage conditions at a UE in accordance with one or more aspects of the present disclosure. The communications manager 720 may be an example of aspects of a communications manager 520, a communications manager 620, or both, as described herein. The communications manager 720, or various components thereof, may be an example of means for performing various aspects of radiated power thresholds for blockage conditions at a UE as described herein. For example, the communications manager 720 may include a control component 725, a capability component 730, a communication component 735, a QoS component 740, a reference signal component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control component 725 is capable of, configured to, or operable to support a means for receiving a control message indicating one or more radiated power thresholds associated with one or more blockage conditions, the one or more blockage conditions distinct from a free-space condition for the UE. The capability component 730 is capable of, configured to, or operable to support a means for transmitting signaling including information that indicates whether the UE is capable of satisfying the one or more radiated power thresholds when communicating under the one or more blockage conditions. The communication component 735 is capable of, configured to, or operable to support a means for communicating, based on the information that indicates whether the UE is capable of satisfying the one or more radiated power thresholds, with a network entity via a set of communication resources.

In some examples, to support transmitting the signaling, the capability component 730 is capable of, configured to, or operable to support a means for transmitting, via the information, an indication of one or more TCI states from among a set of multiple TCI states supported by the UE, where the information indicates that the UE is capable of satisfying the one or more radiated power thresholds when communicating in accordance with the one or more TCI states.

In some examples, to support transmitting the signaling, the capability component 730 is capable of, configured to, or operable to support a means for transmitting, via the information, an indication of one or more antenna modules from among a set of multiple antenna modules of the UE, where the information indicates that the UE is capable of satisfying the one or more radiated power thresholds when communicating using the one or more antenna modules.

In some examples, to support transmitting the signaling, the capability component 730 is capable of, configured to, or operable to support a means for transmitting, via the information, an indication of one or more beamforming procedures supported by the UE, where the information indicates that the UE is capable of satisfying the one or more radiated power thresholds when communicating in accordance with the one or more beamforming procedures.

In some examples, the reference signal component 745 is capable of, configured to, or operable to support a means for receiving a message indicating one or more reference signals for measurement at the UE, where the one or more reference signals are based on the indication of the one or more beamforming procedures supported by the UE.

In some examples, to support transmitting the signaling, the capability component 730 is capable of, configured to, or operable to support a means for transmitting, via the information, one or more bits indicating whether the UE is capable of satisfying the one or more radiated power thresholds when communicating under the one or more blockage conditions.

In some examples, to support communicating with the network entity, the QoS component 740 is capable of, configured to, or operable to support a means for communicating in accordance with one or more QoS parameters, the one or more QoS parameters based on the information.

In some examples, the QoS component 740 is capable of, configured to, or operable to support a means for receiving a second control message that indicates the one or more QoS parameters based on the information.

In some examples, the communication component 735 is capable of, configured to, or operable to support a means for receiving a message that schedules the set of communication resources, where the set of communication resources is based on the information.

In some examples, to support receiving the control message, the control component 725 is capable of, configured to, or operable to support a means for receiving, via the control message, a set of multiple radiated power thresholds, each radiated power threshold of the set of multiple radiated power thresholds corresponding to a respective portion of a spherical area surrounding the UE via which one or more signals transmitted by the UE may radiate.

In some examples, the one or more blockage conditions are associated with an object being within one or more threshold distances of the UE, with one or more respective sizes of the object, or any combination thereof.

In some examples, the object is a hand of a user or a combination of the hand and a head of the user based on a position of the UE relative to the user of the UE.

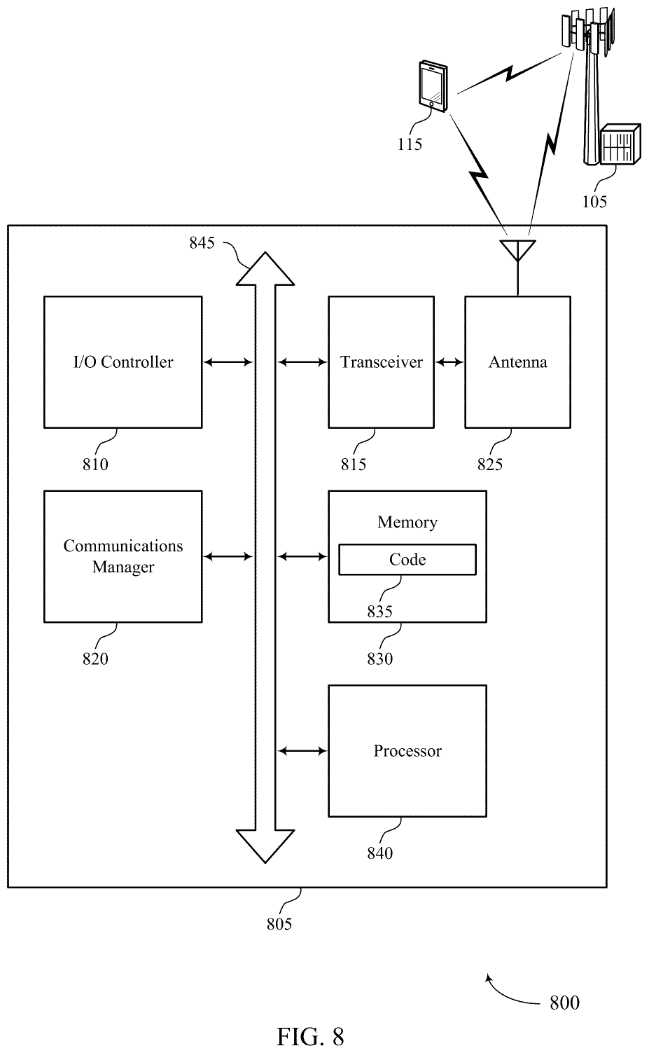

FIG. 8 shows a diagram of a system 800 including a device 805 that supports radiated power thresholds for blockage conditions at a UE in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable code 835 including instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may contain, among other things, a basic I/O system (BIOS) which may control basic hardware or software operation such as the interaction with peripheral components or devices.

The at least one processor 840 may include an intelligent hardware device (e.g., a general-purpose processor, a DSP, a CPU, a GPU, an NPU, a microcontroller, an ASIC, an FPGA, a programmable logic device, a discrete gate or transistor logic component, a discrete hardware component, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting radiated power thresholds for blockage conditions at a UE). For example, the device 805 or a component of the device 805 may include at least one processor 840 and at least one memory 830 coupled with or to the at least one processor 840, the at least one processor 840 and at least one memory 830 configured to perform various functions described herein. In some examples, the at least one processor 840 may include multiple processors and the at least one memory 830 may include multiple memories. One or more of the multiple processors may be coupled with one or more of the multiple memories, which may, individually or collectively, be configured to perform various functions herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. As such, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a control message indicating one or more radiated power thresholds associated with one or more blockage conditions, the one or more blockage conditions distinct from a free-space condition for the UE. The communications manager 820 is capable of, configured to, or operable to support a means for transmitting signaling including information that indicates whether the UE is capable of satisfying the one or more radiated power thresholds when communicating under the one or more blockage conditions. The communications manager 820 is capable of, configured to, or operable to support a means for communicating, based at least in part on the information that indicates whether the UE is capable of satisfying the one or more radiated power thresholds, with a network entity via a set of communication resources.

By including or configuring the communications manager 820 in accordance with examples as described herein, the device 805 may support techniques for improved communication reliability and reduced latency. For example, dynamic indication of radiated power thresholds may enable a UE to be served by a network entity with a greater QoS or with a resource allocation that is associated with a greater reliability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of radiated power thresholds for blockage conditions at a UE as described herein, or the at least one processor 840 and the at least one memory 830 may be otherwise configured to, individually or collectively, perform or support such operations.

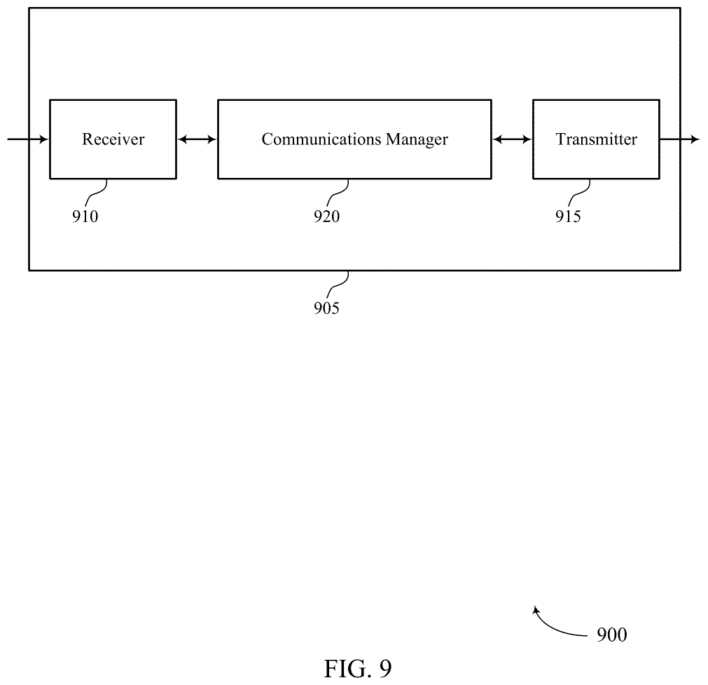

FIG. 9 shows a block diagram 900 of a device 905 that supports radiated power thresholds for blockage conditions at a UE in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of radiated power thresholds for blockage conditions at a UE as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, a GPU, an NPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., communications management software) executed by at least one processor. If implemented in code executed by at least one processor, the functions of the communications manager 920, the receiver 910, the transmitter 915, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for transmitting a control message indicating one or more radiated power thresholds associated with one or more blockage conditions, the one or more blockage conditions distinct from a free-space condition for a UE. The communications manager 920 is capable of, configured to, or operable to support a means for receiving signaling including information that indicates whether the UE is capable of satisfying the one or more radiated power thresholds when communicating under the one or more blockage conditions. The communications manager 920 is capable of, configured to, or operable to support a means for communicating, based at least in part on the information that indicates whether the UE is capable of satisfying the one or more radiated power thresholds, with the UE via a set of communication resources.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources. For example, a network entity may prioritize UEs based on capabilities of the UEs to satisfy various radiated power thresholds, which may result in a more efficient allocation of resources to the UEs. The network entity may expend less processing power to serve UEs with a relatively weaker performance, which may support reduced processing and power consumption.

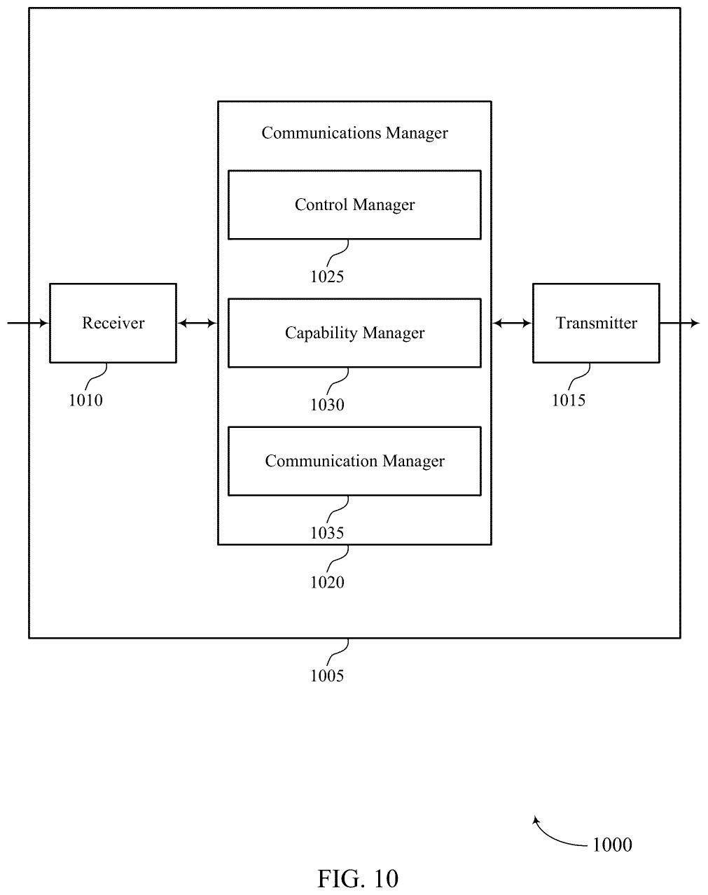

FIG. 10 shows a block diagram 1000 of a device 1005 that supports radiated power thresholds for blockage conditions at a UE in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of radiated power thresholds for blockage conditions at a UE as described herein. For example, the communications manager 1020 may include a control manager 1025, a capability manager 1030, a communication manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control manager 1025 is capable of, configured to, or operable to support a means for transmitting a control message indicating one or more radiated power thresholds associated with one or more blockage conditions, the one or more blockage conditions distinct from a free-space condition for a UE. The capability manager 1030 is capable of, configured to, or operable to support a means for receiving signaling including information that indicates whether the UE is capable of satisfying the one or more radiated power thresholds when communicating under the one or more blockage conditions. The communication manager 1035 is capable of, configured to, or operable to support a means for communicating, based on the information that indicates whether the UE is capable of satisfying the one or more radiated power thresholds, with the UE via a set of communication resources.

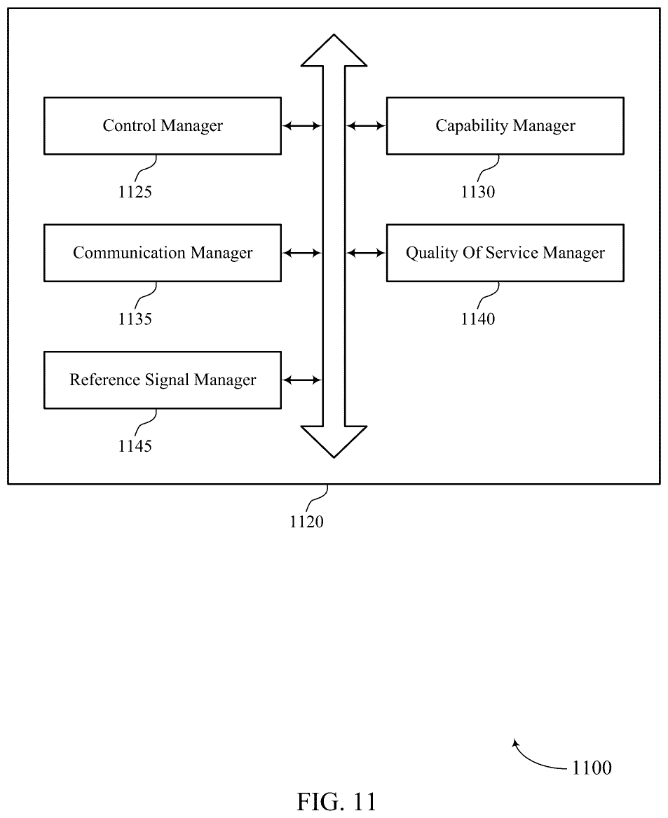

FIG. 11 shows a block diagram 1100 of a communications manager 1120 that supports radiated power thresholds for blockage conditions at a UE in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of radiated power thresholds for blockage conditions at a UE as described herein. For example, the communications manager 1120 may include a control manager 1125, a capability manager 1130, a communication manager 1135, a QoS manager 1140, a reference signal manager 1145, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control manager 1125 is capable of, configured to, or operable to support a means for transmitting a control message indicating one or more radiated power thresholds associated with one or more blockage conditions, the one or more blockage conditions distinct from a free-space condition for a UE. The capability manager 1130 is capable of, configured to, or operable to support a means for receiving signaling including information that indicates whether the UE is capable of satisfying the one or more radiated power thresholds when communicating under the one or more blockage conditions. The communication manager 1135 is capable of, configured to, or operable to support a means for communicating, based on the information that indicates whether the UE is capable of satisfying the one or more radiated power thresholds, with the UE via a set of communication resources.

In some examples, to support receiving the signaling, the capability manager 1130 is capable of, configured to, or operable to support a means for receiving, via the information, an indication of one or more TCI states from among a set of multiple TCI states supported by the UE, where the information indicates that the UE is capable of satisfying the one or more radiated power thresholds when communicating in accordance with the one or more TCI states.

In some examples, to support receiving the signaling, the capability manager 1130 is capable of, configured to, or operable to support a means for receiving, via the information, an indication of one or more antenna modules from among a set of multiple antenna modules of the UE, where the information indicates that the UE is capable of satisfying the one or more radiated power thresholds when communicating using the one or more antenna modules.

In some examples, to support receiving the signaling, the capability manager 1130 is capable of, configured to, or operable to support a means for receiving, via the information, an indication of one or more beamforming procedures supported by the UE, where the information indicates that the UE is capable of satisfying the one or more radiated power thresholds when communicating in accordance with the one or more beamforming procedures.

In some examples, the reference signal manager 1145 is capable of, configured to, or operable to support a means for transmitting a message indicating one or more reference signals for measurement at the UE, where the one or more reference signals are based on the indication of the one or more beamforming procedures supported by the UE.

In some examples, to support receiving the signaling, the capability manager 1130 is capable of, configured to, or operable to support a means for receiving, via the information, one or more bits indicating whether the UE is capable of satisfying the one or more radiated power thresholds when communicating under the one or more blockage conditions.

In some examples, to support communicating with the UE, the QoS manager 1140 is capable of, configured to, or operable to support a means for communicating in accordance with one or more QoS parameters, the one or more QoS parameters based on the information.

In some examples, the QoS manager 1140 is capable of, configured to, or operable to support a means for transmitting a second control message that indicates the one or more QoS parameters based on the information.

In some examples, the communication manager 1135 is capable of, configured to, or operable to support a means for transmitting a message that schedules the set of communication resources, where the set of communication resources is based on the information.

In some examples, to support transmitting the control message, the control manager 1125 is capable of, configured to, or operable to support a means for transmitting, via the control message, a set of multiple radiated power thresholds, each radiated power threshold of the set of multiple radiated power thresholds corresponding to a respective portion of a spherical area surrounding the UE via which one or more signals transmitted by the UE may radiate.

In some examples, the one or more blockage conditions are associated with an object being within one or more threshold distances of the UE, with one or more respective sizes of the object, or any combination thereof.

In some examples, the object is a hand of a user or a combination of the hand and a head of the user based on a position of the UE relative to the user of the UE.

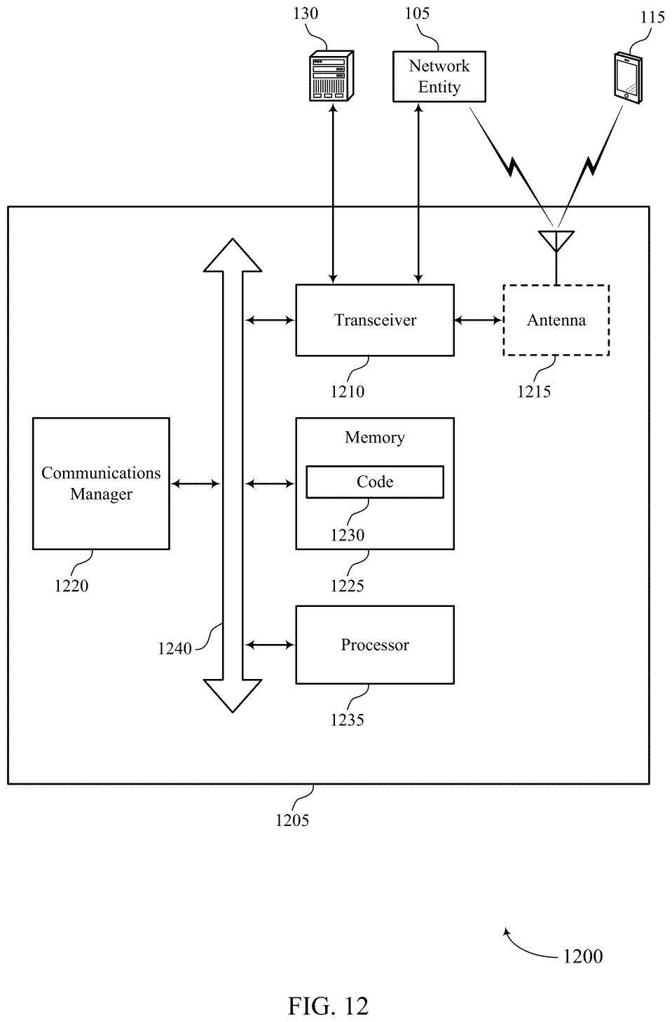

FIG. 12 shows a diagram of a system 1200 including a device 1205 that supports radiated power thresholds for blockage conditions at a UE in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., a communication link 125, a backhaul communication link 120, a midhaul communication link 162, a fronthaul communication link 168).

The at least one memory 1225 may include RAM, ROM, or any combination thereof. The at least one memory 1225 may store computer-readable, computer-executable code 1230 including instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may contain, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include an intelligent hardware device (e.g., a general-purpose processor, a DSP, an ASIC, a CPU, a GPU, an NPU, an FPGA, a microcontroller, a programmable logic device, discrete gate or transistor logic, a discrete hardware component, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting radiated power thresholds for blockage conditions at a UE). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225). In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. As such, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for transmitting a control message indicating one or more radiated power thresholds associated with one or more blockage conditions, the one or more blockage conditions distinct from a free-space condition for a UE. The communications manager 1220 is capable of, configured to, or operable to support a means for receiving signaling including information that indicates whether the UE is capable of satisfying the one or more radiated power thresholds when communicating under the one or more blockage conditions. The communications manager 1220 is capable of, configured to, or operable to support a means for communicating, based at least in part on the information that indicates whether the UE is capable of satisfying the one or more radiated power thresholds, with the UE via a set of communication resources.

By including or configuring the communications manager 1220 in accordance with examples as described herein, the device 1205 may support techniques for improved communication reliability and reduced latency. For example, dynamic indication of radiated power thresholds may enable a UE to be served by a network entity with a greater QoS or with a resource allocation that is associated with a greater reliability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of radiated power thresholds for blockage conditions at a UE as described herein, or the at least one processor 1235 and the at least one memory 1225 may be otherwise configured to, individually or collectively, perform or support such operations.

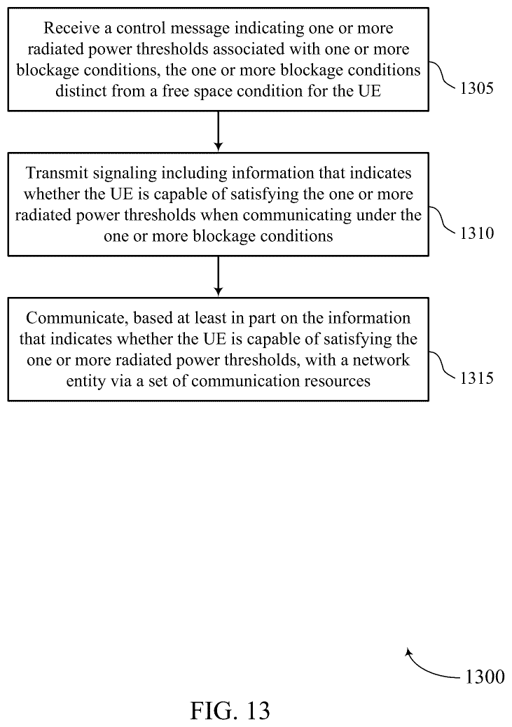

FIG. 13 shows a flowchart illustrating a method 1300 that supports radiated power thresholds for blockage conditions at a UE in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating one or more radiated power thresholds associated with one or more blockage conditions, the one or more blockage conditions distinct from a free-space condition for the UE. The operations of block 1305 may be performed in accordance with examples as disclosed herein. In some examples, aspects of the operations of 1305 may be performed by a control component 725 as described with reference to FIG. 7.

At 1310, the method may include transmitting signaling including information that indicates whether the UE is capable of satisfying the one or more radiated power thresholds when communicating under the one or more blockage conditions. The operations of block 1310 may be performed in accordance with examples as disclosed herein. In some examples, aspects of the operations of 1310 may be performed by a capability component 730 as described with reference to FIG. 7.

At 1315, the method may include communicating, based at least in part on the information that indicates whether the UE is capable of satisfying the one or more radiated power thresholds, with a network entity via a set of communication resources. The operations of block 1315 may be performed in accordance with examples as disclosed herein. In some examples, aspects of the operations of 1315 may be performed by a communication component 735 as described with reference to FIG. 7.

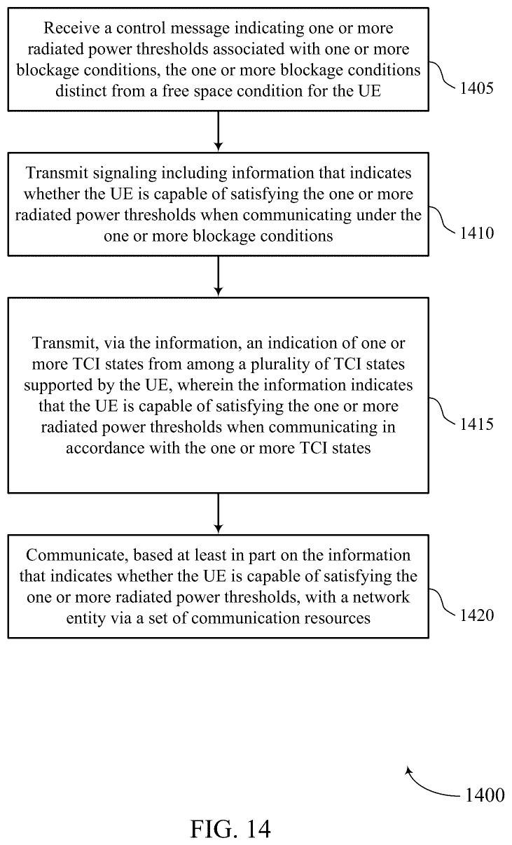

FIG. 14 shows a flowchart illustrating a method 1400 that supports radiated power thresholds for blockage conditions at a UE in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating one or more radiated power thresholds associated with one or more blockage conditions, the one or more blockage conditions distinct from a free-space condition for the UE. The operations of block 1405 may be performed in accordance with examples as disclosed herein. In some examples, aspects of the operations of 1405 may be performed by a control component 725 as described with reference to FIG. 7.

At 1410, the method may include transmitting signaling including information that indicates whether the UE is capable of satisfying the one or more radiated power thresholds when communicating under the one or more blockage conditions. The operations of block 1410 may be performed in accordance with examples as disclosed herein. In some examples, aspects of the operations of 1410 may be performed by a capability component 730 as described with reference to FIG. 7.

At 1415, the method may include transmitting, via the information, an indication of one or more TCI states from among a plurality of TCI states supported by the UE, wherein the information indicates that the UE is capable of satisfying the one or more radiated power thresholds when communicating in accordance with the one or more TCI states. The operations of block 1415 may be performed in accordance with examples as disclosed herein. In some examples, aspects of the operations of 1415 may be performed by a capability component 730 as described with reference to FIG. 7.

At 1420, the method may include communicating, based at least in part on the information that indicates whether the UE is capable of satisfying the one or more radiated power thresholds, with a network entity via a set of communication resources. The operations of block 1420 may be performed in accordance with examples as disclosed herein. In some examples, aspects of the operations of 1420 may be performed by a communication component 735 as described with reference to FIG. 7.

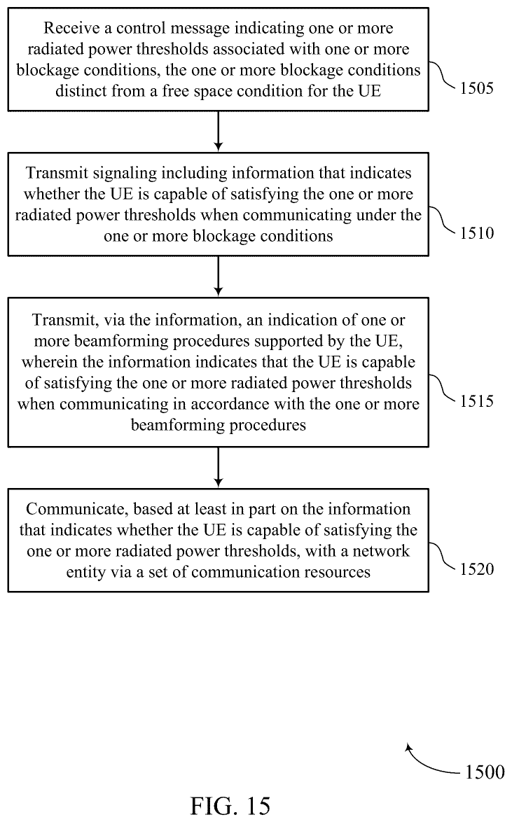

FIG. 15 shows a flowchart illustrating a method 1500 that supports radiated power thresholds for blockage conditions at a UE in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating one or more radiated power thresholds associated with one or more blockage conditions, the one or more blockage conditions distinct from a free-space condition for the UE. The operations of block 1505 may be performed in accordance with examples as disclosed herein. In some examples, aspects of the operations of 1505 may be performed by a control component 725 as described with reference to FIG. 7.

At 1510, the method may include transmitting signaling including information that indicates whether the UE is capable of satisfying the one or more radiated power thresholds when communicating under the one or more blockage conditions. The operations of block 1510 may be performed in accordance with examples as disclosed herein. In some examples, aspects of the operations of 1510 may be performed by a capability component 730 as described with reference to FIG. 7.

At 1515, the method may include transmitting, via the information, an indication of one or more beamforming procedures supported by the UE, wherein the information indicates that the UE is capable of satisfying the one or more radiated power thresholds when communicating in accordance with the one or more beamforming procedures. The operations of block 1515 may be performed in accordance with examples as disclosed herein. In some examples, aspects of the operations of 1515 may be performed by a capability component 730 as described with reference to FIG. 7.

At 1520, the method may include communicating, based at least in part on the information that indicates whether the UE is capable of satisfying the one or more radiated power thresholds, with a network entity via a set of communication resources. The operations of block 1520 may be performed in accordance with examples as disclosed herein. In some examples, aspects of the operations of 1520 may be performed by a communication component 735 as described with reference to FIG. 7.

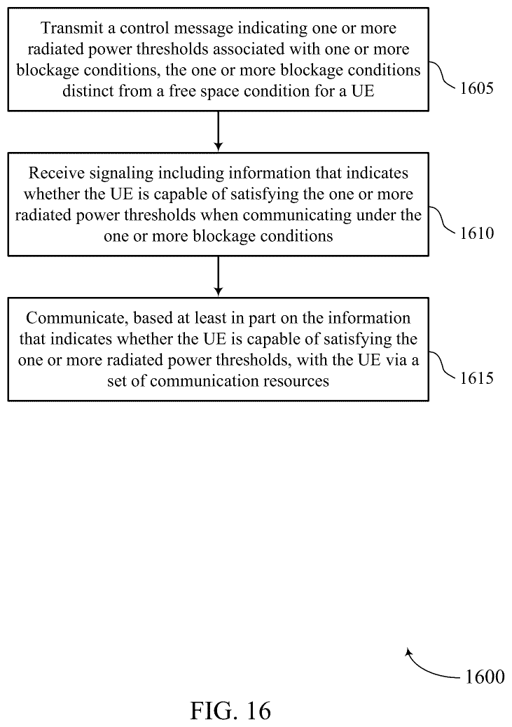

FIG. 16 shows a flowchart illustrating a method 1600 that supports radiated power thresholds for blockage conditions at a UE in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message indicating one or more radiated power thresholds associated with one or more blockage conditions, the one or more blockage conditions distinct from a free-space condition for a UE. The operations of block 1605 may be performed in accordance with examples as disclosed herein. In some examples, aspects of the operations of 1605 may be performed by a control manager 1125 as described with reference to FIG. 11.

At 1610, the method may include receiving signaling including information that indicates whether the UE is capable of satisfying the one or more radiated power thresholds when communicating under the one or more blockage conditions. The operations of block 1610 may be performed in accordance with examples as disclosed herein. In some examples, aspects of the operations of 1610 may be performed by a capability manager 1130 as described with reference to FIG. 11.

At 1615, the method may include communicating, based at least in part on the information that indicates whether the UE is capable of satisfying the one or more radiated power thresholds, with the UE via a set of communication resources. The operations of block 1615 may be performed in accordance with examples as disclosed herein. In some examples, aspects of the operations of 1615 may be performed by a communication manager 1135 as described with reference to FIG. 11.

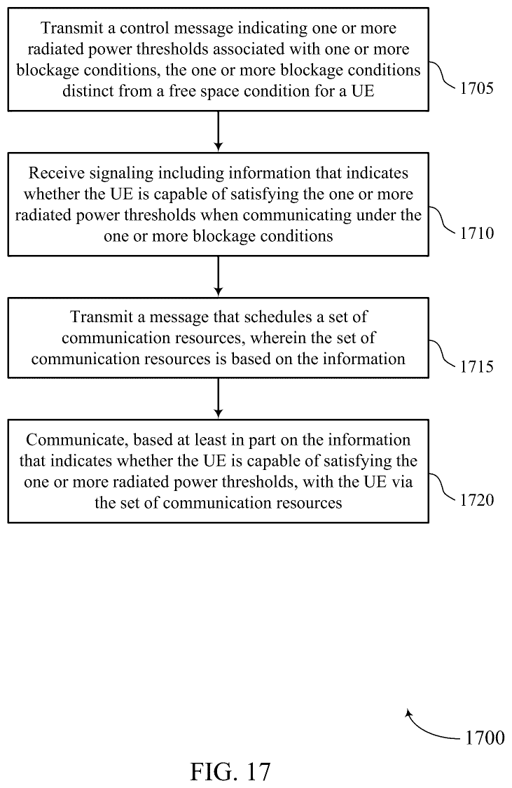

FIG. 17 shows a flowchart illustrating a method 1700 that supports radiated power thresholds for blockage conditions at a UE in accordance with aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a control message indicating one or more radiated power thresholds associated with one or more blockage conditions, the one or more blockage conditions distinct from a free-space condition for a UE. The operations of block 1705 may be performed in accordance with examples as disclosed herein. In some examples, aspects of the operations of 1705 may be performed by a control manager 1125 as described with reference to FIG. 11.

At 1710, the method may include receiving signaling including information that indicates whether the UE is capable of satisfying the one or more radiated power thresholds when communicating under the one or more blockage conditions. The operations of block 1710 may be performed in accordance with examples as disclosed herein. In some examples, aspects of the operations of 1710 may be performed by a capability manager 1130 as described with reference to FIG. 11.

At 1715, the method may include transmitting a message that schedules the set of communication resources, wherein the set of communication resources is based on the information. The operations of block 1715 may be performed in accordance with examples as disclosed herein. In some examples, aspects of the operations of 1715 may be performed by a communication manager 1135 as described with reference to FIG. 11.

At 1720, the method may include communicating, based at least in part on the information that indicates whether the UE is capable of satisfying the one or more radiated power thresholds, with the UE via a set of communication resources. The operations of block 1720 may be performed in accordance with examples as disclosed herein. In some examples, aspects of the operations of 1720 may be performed by a communication manager 1135 as described with reference to FIG. 11.

The following provides an overview of aspects of the present disclosure:

Aspect 1: A method for wireless communications by a UE, comprising: receiving a control message indicating one or more radiated power thresholds associated with one or more blockage conditions, the one or more blockage conditions distinct from a free-space condition for the UE; transmitting signaling comprising information that indicates whether the UE is capable of satisfying the one or more radiated power thresholds when communicating under the one or more blockage conditions; and communicating, based at least in part on the information that indicates whether the UE is capable of satisfying the one or more radiated power thresholds, with a network entity via a set of communication resources.

Aspect 2: The method of aspect 1, wherein transmitting the signaling comprises: transmitting, via the information, an indication of one or more TCI states from among a plurality of TCI states supported by the UE, wherein the information indicates that the UE is capable of satisfying the one or more radiated power thresholds when communicating in accordance with the one or more TCI states.

Aspect 3: The method of any of aspects 1 through 2, wherein transmitting the signaling comprises: transmitting, via the information, an indication of one or more antenna modules from among a plurality of antenna modules of the UE, wherein the information indicates that the UE is capable of satisfying the one or more radiated power thresholds when communicating using the one or more antenna modules.

Aspect 4: The method of any of aspects 1 through 3, wherein transmitting the signaling comprises: transmitting, via the information, an indication of one or more beamforming procedures supported by the UE, wherein the information indicates that the UE is capable of satisfying the one or more radiated power thresholds when communicating in accordance with the one or more beamforming procedures.

Aspect 5: The method of aspect 4, further comprising: receiving a message indicating one or more reference signals for measurement at the UE, wherein the one or more reference signals are based at least in part on the indication of the one or more beamforming procedures supported by the UE.

Aspect 6: The method of any of aspects 1 through 5, wherein transmitting the signaling comprises: transmitting, via the information, one or more bits indicating whether the UE is capable of satisfying the one or more radiated power thresholds when communicating under the one or more blockage conditions.

Aspect 7: The method of any of aspects 1 through 6, wherein communicating with the network entity comprises: communicating in accordance with one or more QoS parameters, the one or more QoS parameters based at least in part on the information.

Aspect 8: The method of aspect 7, further comprising: receiving a second control message that indicates the one or more QoS parameters based at least in part on the information.

Aspect 9: The method of any of aspects 1 through 8, further comprising: receiving a message that schedules the set of communication resources, wherein the set of communication resources is based at least in part on the information.

Aspect 10: The method of any of aspects 1 through 9, wherein receiving the control message comprises: receiving, via the control message, a plurality of radiated power thresholds, each radiated power threshold of the plurality of radiated power thresholds corresponding to a respective portion of a spherical area surrounding the UE via which one or more signals transmitted by the UE may radiate.

Aspect 11: The method of any of aspects 1 through 10, wherein the one or more blockage conditions are associated with an object being within one or more threshold distances of the UE, with one or more respective sizes of the object, or any combination thereof.

Aspect 12: The method of aspect 11, wherein the object is a hand of a user or a combination of the hand and a head of the user based at least in part on a position of the UE relative to the user of the UE.

Aspect 13: A method for wireless communications by a network entity, comprising: transmitting a control message indicating one or more radiated power thresholds associated with one or more blockage conditions, the one or more blockage conditions distinct from a free-space condition for a UE; receiving signaling comprising information that indicates whether the UE is capable of satisfying the one or more radiated power thresholds when communicating under the one or more blockage conditions; and communicating, based at least in part on the information that indicates whether the UE is capable of satisfying the one or more radiated power thresholds, with the UE via a set of communication resources.

Aspect 14: The method of aspect 13, wherein receiving the signaling comprises: receiving, via the information, an indication of one or more TCI states from among a plurality of TCI states supported by the UE, wherein the information indicates that the UE is capable of satisfying the one or more radiated power thresholds when communicating in accordance with the one or more TCI states.

Aspect 15: The method of any of aspects 13 through 14, wherein receiving the signaling comprises: receiving, via the information, an indication of one or more antenna modules from among a plurality of antenna modules of the UE, wherein the information indicates that the UE is capable of satisfying the one or more radiated power thresholds when communicating using the one or more antenna modules.

Aspect 16: The method of any of aspects 13 through 15, wherein receiving the signaling comprises: receiving, via the information, an indication of one or more beamforming procedures supported by the UE, wherein the information indicates that the UE is capable of satisfying the one or more radiated power thresholds when communicating in accordance with the one or more beamforming procedures.

Aspect 17: The method of aspect 16, further comprising: transmitting a message indicating one or more reference signals for measurement at the UE, wherein the one or more reference signals are based at least in part on the indication of the one or more beamforming procedures supported by the UE.

Aspect 18: The method of any of aspects 13 through 17, wherein receiving the signaling comprises: receiving, via the information, one or more bits indicating whether the UE is capable of satisfying the one or more radiated power thresholds when communicating under the one or more blockage conditions.

Aspect 19: The method of any of aspects 13 through 18, wherein communicating with the UE comprises: communicating in accordance with one or more QoS parameters, the one or more QoS parameters based at least in part on the information.

Aspect 20: The method of aspect 19, further comprising: transmitting a second control message that indicates the one or more QoS parameters based at least in part on the information.

Aspect 21: The method of any of aspects 13 through 20, further comprising: transmitting a message that schedules the set of communication resources, wherein the set of communication resources is based at least in part on the information.

Aspect 22: The method of any of aspects 13 through 21, wherein transmitting the control message comprises: transmitting, via the control message, a plurality of radiated power thresholds, each radiated power threshold of the plurality of radiated power thresholds corresponding to a respective portion of a spherical area surrounding the UE via which one or more signals transmitted by the UE may radiate.

Aspect 23: The method of any of aspects 13 through 22, wherein the one or more blockage conditions are associated with an object being within one or more threshold distances of the UE, with one or more respective sizes of the object, or any combination thereof.

Aspect 24: The method of aspect 23, wherein the object is a hand of a user or a combination of the hand and a head of the user based at least in part on a position of the UE relative to the user of the UE.

Aspect 25: A UE for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the UE to perform a method of any of aspects 1 through 12.

Aspect 26: A UE for wireless communications, comprising at least one means for performing a method of any of aspects 1 through 12.

Aspect 27: A non-transitory computer-readable medium storing code for wireless communications at a UE, the code comprising instructions executable by at least one processor (e.g., directly, indirectly, after pre-processing, without pre-processing) to perform a method of any of aspects 1 through 12.

Aspect 28: A network entity for wireless communications, comprising one or more memories storing processor-executable code, and one or more processors coupled with (e.g., operatively, communicatively, functionally, electronically, or electrically) the one or more memories and individually or collectively operable to execute the code (e.g., directly, indirectly, after pre-processing, without pre-processing) to cause the network entity to perform a method of any of aspects 13 through 24.

Aspect 29: A network entity for wireless communications, comprising at least one means for performing a method of any of aspects 13 through 24.

Aspect 30: A non-transitory computer-readable medium storing code for wireless communications at a UE, the code comprising instructions executable by at least one processor (e.g., directly, indirectly, after pre-processing, without pre-processing) to perform a method of any of aspects 13 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Wi-Fi (e.g., Institute of Electrical and Electronics Engineers (IEEE) 802.11), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a control message indicating one or more radiated power thresholds associated with one or more blockage conditions, the one or more blockage conditions distinct from a free-space condition for the UE;
transmit signaling comprising information that indicates whether the UE is capable of satisfying the one or more radiated power thresholds when communicating under the one or more blockage conditions; and
communicating, based at least in part on the information, with a network entity via a set of communication resources.

2. The UE of claim 1, wherein, to transmit the signaling, the one or more processors are individually or collectively operable to execute the code to cause the UE to:
transmit, via the information, an indication of one or more transmission configuration indicator states from among a plurality of transmission configuration indicator states supported by the UE, wherein the information indicates that the UE is capable of satisfying the one or more radiated power thresholds when communicating in accordance with the one or more transmission configuration indicator states.

3. The UE of claim 1, wherein, to transmit the signaling, the one or more processors are individually or collectively operable to execute the code to cause the UE to:
transmit, via the information, an indication of one or more antenna modules from among a plurality of antenna modules of the UE, wherein the information indicates that the UE is capable of satisfying the one or more radiated power thresholds when communicating using the one or more antenna modules.

4. The UE of claim 1, wherein, to transmit the signaling, the one or more processors are individually or collectively operable to execute the code to cause the UE to:
transmit, via the information, an indication of one or more beamforming procedures supported by the UE, wherein the information indicates that the UE is capable of satisfying the one or more radiated power thresholds when communicating in accordance with the one or more beamforming procedures.

5. The UE of claim 4, wherein the one or more processors are individually or collectively further operable to execute the code to cause the UE to:
receive a message indicating one or more reference signals for measurement at the UE, wherein the one or more reference signals are based at least in part on the indication of the one or more beamforming procedures supported by the UE.

6. The UE of claim 1, wherein, to transmit the signaling, the one or more processors are individually or collectively operable to execute the code to cause the UE to:
transmit, via the information, one or more bits indicating whether the UE is capable of satisfying the one or more radiated power thresholds when communicating under the one or more blockage conditions.

7. The UE of claim 1, wherein, to communicate with the network entity, the one or more processors are individually or collectively operable to execute the code to cause the UE to:
communicate in accordance with one or more quality of service parameters, the one or more quality of service parameters based at least in part on the information.

8. The UE of claim 7, wherein the one or more processors are individually or collectively further operable to execute the code to cause the UE to:
receive a second control message that indicates the one or more quality of service parameters based at least in part on the information.

9. The UE of claim 1, wherein the one or more processors are individually or collectively further operable to execute the code to cause the UE to:
receive a message that schedules the set of communication resources, wherein the set of communication resources is based at least in part on the information.

10. The UE of claim 1, wherein, to receive the control message, the one or more processors are individually or collectively operable to execute the code to cause the UE to:
receive, via the control message, a plurality of radiated power thresholds, each radiated power threshold of the plurality of radiated power thresholds corresponding to a respective portion of a spherical area surrounding the UE via which one or more signals transmitted by the UE may radiate.

11. The UE of claim 1, wherein the one or more blockage conditions are associated with an object being within one or more threshold distances of the UE, with one or more respective sizes of the object, or any combination thereof.

12. The UE of claim 11, wherein the object is a hand of a user or a combination of the hand and a head of the user based at least in part on a position of the UE relative to the user of the UE.

13. A network entity, comprising:
one or more memories storing processor-executable code; and
one or more processors coupled with the one or more memories and individually or collectively operable to execute the code to cause the network entity to:
transmit a control message indicating one or more radiated power thresholds associated with one or more blockage conditions, the one or more blockage conditions distinct from a free-space condition for a user equipment (UE);
receive signaling comprising information that indicates whether the UE is capable of satisfying the one or more radiated power thresholds when communicating under the one or more blockage conditions; and
communicating, based at least in part on the information, with the UE via a set of communication resources.

14. The network entity of claim 13, wherein, to receive the signaling, the one or more processors are individually or collectively operable to execute the code to cause the network entity to:
receive, via the information, an indication of one or more transmission configuration indicator states from among a plurality of transmission configuration indicator states supported by the UE, wherein the information indicates that the UE is capable of satisfying the one or more radiated power thresholds when communicating in accordance with the one or more transmission configuration indicator states.

15. The network entity of claim 13, wherein, to receive the signaling, the one or more processors are individually or collectively operable to execute the code to cause the network entity to:
receive, via the information, an indication of one or more antenna modules from among a plurality of antenna modules of the UE, wherein the information indicates that the UE is capable of satisfying the one or more radiated power thresholds when communicating using the one or more antenna modules.

16. The network entity of claim 13, wherein, to receive the signaling, the one or more processors are individually or collectively operable to execute the code to cause the network entity to:
receive, via the information, an indication of one or more beamforming procedures supported by the UE, wherein the information indicates that the UE is capable of satisfying the one or more radiated power thresholds when communicating in accordance with the one or more beamforming procedures.

17. The network entity of claim 16, wherein the one or more processors are individually or collectively further operable to execute the code to cause the network entity to:
transmit a message indicating one or more reference signals for measurement at the UE, wherein the one or more reference signals are based at least in part on the indication of the one or more beamforming procedures supported by the UE.

18. The network entity of claim 13, wherein, to receive the signaling, the one or more processors are individually or collectively operable to execute the code to cause the network entity to:
receive, via the information, one or more bits indicating whether the UE is capable of satisfying the one or more radiated power thresholds when communicating under the one or more blockage conditions.

19. The network entity of claim 13, wherein, to communicate with the UE, the one or more processors are individually or collectively operable to execute the code to cause the network entity to:
communicate in accordance with one or more quality of service parameters, the one or more quality of service parameters based at least in part on the information.

20. The network entity of claim 19, wherein the one or more processors are individually or collectively further operable to execute the code to cause the network entity to:
transmit a second control message that indicates the one or more quality of service parameters based at least in part on the information.

21. The network entity of claim 13, wherein the one or more processors are individually or collectively further operable to execute the code to cause the network entity to:
transmit a message that schedules the set of communication resources, wherein the set of communication resources is based at least in part on the information.

22. The network entity of claim 13, wherein, to transmit the control message, the one or more processors are individually or collectively operable to execute the code to cause the network entity to:
transmit, via the control message, a plurality of radiated power thresholds, each radiated power threshold of the plurality of radiated power thresholds corresponding to a respective portion of a spherical area surrounding the UE via which one or more signals transmitted by the UE may radiate.

23. The network entity of claim 13, wherein the one or more blockage conditions are associated with an object being within one or more threshold distances of the UE, with one or more respective sizes of the object, or any combination thereof.

24. The network entity of claim 23, wherein the object is a hand of a user or a combination of the hand and a head of the user based at least in part on a position of the UE relative to the user of the UE.

25. A method for wireless communications by a user equipment (UE), comprising:
receiving a control message indicating one or more radiated power thresholds associated with one or more blockage conditions, the one or more blockage conditions distinct from a free-space condition for the UE;
transmitting signaling comprising information that indicates whether the UE is capable of satisfying the one or more radiated power thresholds when communicating under the one or more blockage conditions; and
communicating, based at least in part on the information, with a network entity via a set of communication resources.

26. The method of claim 25, wherein transmitting the signaling comprises:
transmitting, via the information, an indication of one or more transmission configuration indicator states from among a plurality of transmission configuration indicator states supported by the UE, wherein the information indicates that the UE is capable of satisfying the one or more radiated power thresholds when communicating in accordance with the one or more transmission configuration indicator states.

27. The method of claim 25, wherein transmitting the signaling comprises:
transmitting, via the information, an indication of one or more antenna modules from among a plurality of antenna modules of the UE, wherein the information indicates that the UE is capable of satisfying the one or more radiated power thresholds when communicating using the one or more antenna modules.

28. The method of claim 25, wherein transmitting the signaling comprises:
transmitting, via the information, an indication of one or more beamforming procedures supported by the UE, wherein the information indicates that the UE is capable of satisfying the one or more radiated power thresholds when communicating in accordance with the one or more beamforming procedures.

29. The method of claim 25, wherein transmitting the signaling comprises:
transmitting, via the information, one or more bits indicating whether the UE is capable of satisfying the one or more radiated power thresholds when communicating under the one or more blockage conditions.

30. A method for wireless communications by a network entity, comprising:
transmitting a control message indicating one or more radiated power thresholds associated with one or more blockage conditions, the one or more blockage conditions distinct from a free-space condition for a user equipment (UE);
receiving signaling comprising information that indicates whether the UE is capable of satisfying the one or more radiated power thresholds when communicating under the one or more blockage conditions; and
communicating, based at least in part on the information, with the UE via a set of communication resources.
